(19) United States
(12) Patent Application Publication
(10) Pub. No.: US 2017/0316062 A1
(43) Pub. Date: Nov. 2, 2017

(54) SEARCH METHOD AND APPARATUS

(71) Applicant: BEIJING ZHIGU RUI TUO TECH CO., LTD., BEIJING (CN)

(72) Inventors: JIA LIU, BEIJING (CN); LIANG ZHOU, BEIJING (CN)

(21) Appl. No.: 15/526,270

(22) PCT Filed: Oct. 10, 2015
(86) PCT No.: PCT/CN2015/091656

§ 371 Date: May 11, 2017

(30) Foreign Application Priority Data
Nov. 25, 2014 (CN) 201410685943.2

(51) Int. Cl. G06F 17/30

(52) U.S. Cl. CPC G06F 17/30528; G06F 17/30554; G06F 17/30864

(57) ABSTRACT

Embodiments of the present application provide a search method and apparatus. The search method comprises: in response to a predetermined movement of at least one body part on a display screen, determining at least one piece of content associated with at least one biological feature of the at least one body part; and performing a search at least according to the at least one piece of content. The embodiments of the present application provide a search solution.

### RELATED APPLICATION

The present international patent cooperative treaty (PCT) application claims the benefit of priority to Chinese Patent Application No. 201410685943.2, filed on Nov. 25, 2014, and entitled “Search Method and Apparatus”, which is incorporated in the present application by reference herein in its entirety.

### TECHNICAL FIELD

Embodiments of the present application relate to the field of interaction technologies, and in particular, to a search method and apparatus.

### BACKGROUND

Search is a common means of acquiring information and locating information. A typical scenario is that a user needs to rapidly locate a certain keyword in a currently browsed document. An existing manner includes bringing up a search input box, inputting the keyword, and clicking a searching button. Another typical scenario is that a user needs to acquire information related to a certain keyword. An existing manner includes opening a search engine web page, inputting the keyword in a search input box in the web page, and clicking the searching button.

### SUMMARY

In view of this, one objective of embodiments of the present application lies in providing a search solution.

In order to achieve the above objective, according to a first aspect of the embodiments of the present application, a search method is provided, comprising:

in response to a predetermined movement of at least one body part on a display screen, determining at least one piece of content associated with at least one biological feature of the at least one body part; and

performing a search at least according to the at least one piece of content.

In order to achieve the above objective, according to a second aspect of the embodiments of the present application, a search apparatus is provided, comprising:

a first determination module, configured to respond to a predetermined movement of at least one body part on a display screen, and determine at least one piece of content associated with at least one biological feature of the at least one body part; and

a search module, configured to perform a search at least according to the at least one piece of content.

At least one technical solution in the multiple technical solutions has the following beneficial effects:

in the embodiments of the present application, a search solution is provided by, in response to a predetermined movement of at least one body part on a display screen, determining at least one piece of content associated with at least one biological feature of the at least one body part; and performing a search at least according to the at least one piece of content. Moreover, a search entrance is opened and content needed by a search is provided for the search entrance by means of a predetermined movement of at least one body part, which speeds up the search.

### BRIEF DESCRIPTION OF THE DRAWINGS

FIG. 1 is a schematic flowchart of a search method embodiment provided in the present application;

FIG. 2 is a schematic structural diagram of a search apparatus in Embodiment 1 provided in the present application;

FIG. 3 to FIG. 6 are schematic structural diagrams according to the embodiment shown in FIG. 2; and

FIG. 7 is a schematic structural diagram of a search apparatus in Embodiment 2 provided in the present application.

### DETAILED DESCRIPTION

The following further describes a specific embodiment of the present application in detail in combination with the accompanying drawings and embodiments. The following embodiments are used to describe the present application, but not intended to limit the scope of the present application.

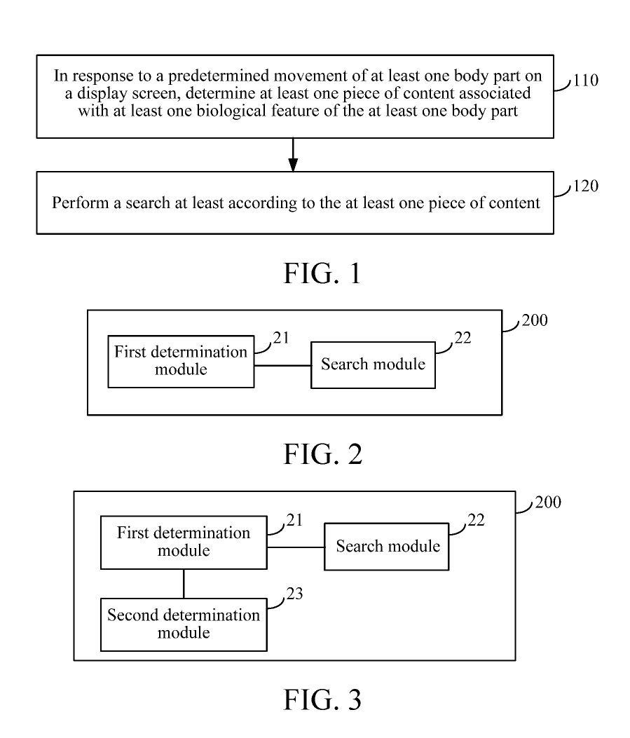

FIG. 1 is a schematic flowchart of a search method embodiment provided in the present application. As shown in FIG. 1, this embodiment comprises:

110. In response to a predetermined movement of at least one body part on a display screen, determine at least one piece of content associated with at least one biological feature of the at least one body part.

For example, a search apparatus in Embodiment 1 or Embodiment 2 provided in the present application acts as an entity for performing this embodiment, i.e. performing steps 110 to 120. Optionally, the search apparatus is set in a user terminal in a manner of hardware and/or software. Further, the display screen is also set in the user terminal, or the display screen is connected to the user terminal.

In this embodiment, the at least one body part comprises, but not limited to, at least one of the following: at least one finger, at least one palm, at least one toe, or at least one sole.

In this embodiment, the predetermined movement comprises, but not limited to, any one of the following: a double-click, a triple-click, pressing concurrently with a double-click, and pressing concurrently with a triple-click. For example, if the at least one body part is at least one finger, the double-click may be a finger performing a double-click on the display screen, or two fingers performing the double-click on the display screen simultaneously, or the like; and pressing concurrently with a double-click may be one finger pressing the display screen and the other finger performing the double-click on the display screen simultaneously, or one finger pressing the display screen and another two fingers performing the double-click on the display screen simultaneously, or the like.

In this embodiment, the predetermined movement of the at least one body part on the display screen may be detected by the search apparatus, and may also be detected and determined by another apparatus that notifies the search apparatus.

In this embodiment, at least one biological feature of each body part may identify the body part. For example, at least one biological feature of a finger may comprise a fingerprint of the finger; at least one biological feature of a toe may comprise a toe print of the toe; at least one biological feature of a palm may comprise a palm print of the palm; at least one biological feature of a sole may comprise a sole print of the sole.

In this embodiment, the at least one piece of content comprises, but not limited to, at least one of the following content: character, picture, audio clip, and video clip. The character comprises, but not limited to, at least one of the following characters: letter, number, word, symbol, and the like.

In this embodiment, an association relationship between the at least one biological feature and the at least one piece of content may be pre-established. Specifically, the association relationship may be one biological feature associated with one piece of content, or one biological feature associated with multiple pieces of content, or multiple biological features associated with one piece of content, or multiple biological features associated with multiple pieces of content. Optionally, in a process in which a user uses at least one body part to select at least one piece of content on the display screen, an association relationship between at least one biological feature of the at least one body part and the selected at least one piece of content is established. For example, a user uses an index finger and a middle finger of his right hand selecting one piece of content displayed on the display screen. Correspondingly, an association relationship between an index finger fingerprint and a middle finger fingerprint of the right hand of the user and the content may be established, that is, two biological features are associated with one piece of content. A user uses an index finger of his right hand selecting one piece of content A displayed on the display screen, and a middle finger of his right hand selecting another piece of content B displayed on the display screen simultaneously. Correspondingly, an association relationship between an index finger fingerprint of the right hand of the user and the content A and an association relationship between a middle finger fingerprint of the right hand of the user and the content B may be established, that is, two biological features are respectively associated with two pieces of content.

120. Perform a search at least according to the at least one piece of content.

In this embodiment, the at least one piece of content is used as content provided for a search entrance in the search, and a function thereof is similar to a search word or a search strategy.

In this embodiment, a search solution is provided by, in response to a predetermined movement of at least one body part on a display screen, determining at least one piece of content associated with at least one biological feature of the at least one body part; and performing a search at least according to the at least one piece of content. Moreover, a search entrance is opened and content needed by a search is provided for the search entrance by means of a predetermined movement of at least one body part, which speeds up the search.

The following further describes the method in this embodiment through some optional embodiments.

In this embodiment, 110 has multiple embodiments.

In a possible scenario, the at least one body part is one body part. Correspondingly, the in response to a predetermined movement of at least one body part on a display screen, determining at least one piece of content associated with at least one biological feature of the at least one body part comprises:

in response to a predetermined movement of the one body part on the display screen, determining at least one piece of content associated with at least one biological feature of the body part.

In another possible scenario, the at least one body part includes multiple body parts. Correspondingly, the in response to a predetermined movement of at least one body part on a display screen, determining at least one piece of content associated with at least one biological feature of the at least one body part comprises:

in response to a predetermined movement of the multiple body parts on the display screen, determining at least one piece of content associated with multiple biological features of the multiple body parts.

In this scenario, optionally, the in response to a predetermined movement of at least one body part on a display screen, determining at least one piece of content associated with at least one biological feature of the at least one body part comprises:

in response to a predetermined movement of at least one body part on the display screen, determining multiple pieces of content associated with multiple biological features of the multiple body parts.

In this scenario, optionally, this embodiment further comprises:

determining relative location relationships and/or relative motions of the multiple body parts on the display screen.

The relative location relationships comprise, but are not limited to, at least one of the following: a distance, an upper-lower relationship, and a left-right relationship. For example, a distance of two fingers of a user on the display screen may be 1 cm, 2 cm, or the like; an upper-lower relationship of two fingers of a user on the display screen may be one finger being upper and the other finger being lower, or the two fingers being horizontally aligned; and a left-right relationship of two fingers of a user on the display screen may be one finger being left and the other finger being right, or the two fingers being vertical aligned.

The relative motions comprise, but are not limited to, any one of the following: motions in the same direction, motions in face to face directions, and motions in back to back directions. Specifically, the motions in the same direction refer to moving substantially in a same direction; the motions in face to face directions refer to moving substantially in opposite directions towards a same location; and the motions in back to back directions refer to moving substantially in opposite directions from a same location.

In consideration of the predetermined movement executed by the multiple body parts on the display screen, the relative motions may be relative motions after the multiple body parts have executed the predetermined movement on the display screen.

Considering that the multiple body parts may move on the display screen, the relative location relationships may be relative location relationships when the multiple body parts execute the predetermined movement on the display screen, or relative location relationships after the multiple body parts have executed the predetermined movement and completed relative motion.

Specifically, the determining relative location relationships and/or relative motions of the multiple body parts on the display screen comprises: determining the relative location relationships of the multiple body parts on the display screen; or determining the relative motions of the multiple body parts on the display screen; or determining the relative location relationships and the relative motions of the multiple body parts on the display screen.

Further, the relative location relationships and/or the relative motions may have multiple functions in the search.

Optionally, the performing a search at least according to the at least one piece of content comprises:

determining a search range according to the relative location relationships and/or the relative motions; and

performing the search in the search range at least according to multiple pieces of content.

Specifically, the search range is a search range related to content displayed on the display screen or a search range related to a device corresponding to the display screen. The device corresponding to the display screen is a source of content being displayed on the display screen.

Optionally, the search range comprises, but not limited to, any one of the following: at least one piece of content being displayed on at least one contact area of the at least one body part and the display screen, at least one piece of content being displayed on the display screen, at least one application program corresponding to at least one piece of content being displayed on the display screen, at least one application program being run by a device corresponding to the display screen, and at least one database connected to a device corresponding to the display screen, wherein the at least one database may be connected to the device through a network.

For example, a user uses a finger to execute a predetermined movement on a display screen of a mobile phone, and the mobile phone is running two application programs, wherein one is a document editing program, and the other is a web page browser; the document editing program opens two documents, and the web page browser opens two web pages; and the display screen is displaying page 2 of a document, and the finger is in contact with a location of a word in a paragraph displayed on the display screen. Correspondingly, the search range may be the paragraph, or the document being displayed, or the two documents opened by the document editing program, or the two documents opened by the document editing program and the two web pages opened by the web page browser, or all network search engines to which the mobile phone can be connected, or the like.

Specifically, the determining a search range according to the relative location relationships and/or the relative motions comprises: determining the search range according to the relative location relationships; or determining the search range according to the relative motions; or determining the search range according to the relative location relationships and the relative motions.

For example, when a distance of two fingers that execute the predetermined movement on the display screen on the display screen is short, for example, when the distance is shorter than 2 cm, it is determined that the search range is at least one piece of content being displayed on at least one contact area of the two fingers of the display screen; and when a distance of the two fingers that execute the predetermined movement on the display screen on the display screen is long, for example, when the distance is longer than 2 cm, it is determined that the search range is the at least one application program corresponding to the at least one piece of content being displayed on the display screen.

For another example, when the two fingers that execute the predetermined movement on the display screen make the motion in back to back directions on the display screen after completing the predetermined movement, it is determined that the search range is the at least one database connected to the device corresponding to the display screen; and when the two fingers that execute the predetermined movement on the display screen make the motion in the same direction on the display screen after completing the predetermined movement, it is determined that the search range is the at least one application program being run by the device corresponding to the display screen.

For another example, when one of the two fingers that execute the predetermined movement on the display screen is upper and the other is lower, and the two fingers make the motion in face to face directions on the display screen after completing the predetermined movement, it is determined that the search range is the at least one piece of content being displayed on the display screen; and when the two fingers that execute the predetermined movement on the display screen are horizontally aligned on the display screen, and the two fingers make the motion in back to back directions on the display screen after completing the predetermined movement, it is determined that the search range is the at least one application program being run by the device corresponding to the display screen.

In the foregoing scenario in which in response to a predetermined movement of multiple body parts on the display screen, multiple pieces of content associated with multiple biological features of the multiple body parts are determined, optionally, the performing a search at least according to the at least one piece of content comprises:

determining logical relationships between the multiple pieces of content according to the multiple pieces of content, and the relative location relationships and/or the relative motions; and

performing the search at least according to the multiple pieces of content and the logical relationships between the multiple pieces of content.

Specifically, the logical relationships may comprise, but not limited to, at least one of the following relationships: and, or, xor, or the like.

Specifically, the determining logical relationships between the multiple pieces of content according to the multiple pieces of content, and the relative location relationships and/or the relative motions comprises: determining the logical relationships between the multiple pieces of content according to the multiple pieces of content and the relative location relationships; determining the logical relationships between the multiple pieces of content according to the multiple pieces of content and the relative motions; and determining the logical relationships between the multiple pieces of content according to the multiple pieces of content, and the relative location relationships and the relative motions.

For example, when a distance of the two fingers that execute the predetermined movement on the display screen on the display screen is short, for example, when the distance is shorter than 2 cm, it is determined that a logical relationship between two pieces of content respectively associated with fingerprints of the two fingers is “and”; when a distance of the two fingers that execute the predetermined movement on the display screen on the display screen is long, for example, when the distance is longer than 2 cm, it is determined that the logical relationship between the two pieces of content respectively associated with the fingerprints of the two fingers is “or”; and when a distance of two fingers of three fingers that execute the predetermined movement on the display screen on the display screen is short, and a distance between the two fingers and the another finger is long, it is determined that a logical relationship between content associated with the fingerprints of the two fingers between which the distance is short is “and”, and a logical relationship between the content associated with the fingerprints of the two fingers between which the distance is short and content associated with a fingerprint of the another finger is “or”.

For another example, when the two fingers that execute the predetermined movement on the display screen make the motion in back to back directions on the display screen after completing the predetermined movement, it is determined that the logical relationship between the two pieces of content respectively associated with the fingerprints of the two fingers is “xor” (exclusive or); and when the two fingers that execute the predetermined movement on the display screen make the motion in the same direction on the display screen after completing the predetermined movement, it is determined that the logical relationship between the two pieces of content respectively associated with the fingerprints of the two fingers is “and”.

For another example, when one of the two fingers that execute the predetermined movement on the display screen is upper and the other is lower, and the two fingers make the motion in back to back directions on the display screen after completing the predetermined movement, it is determined that a logical relationship between two pieces of content respectively associated with fingerprints of the two fingers is content associated with an upper fingerprint “xor” content associated with a lower fingerprint; and when the two fingers that execute the predetermined movement on the display screen are horizontally aligned on the display screen, and the two fingers make the motion in the same directions on the display screen after completing the predetermined movement, it is determined that the logical relationship between the two pieces of content respectively associated with the fingerprints of the two fingers is “and”.

In this embodiment, the search generally has a search range.

Optionally, the performing a search at least according to the at least one piece of content comprises:

performing the search in a search range at least according to the at least one piece of content.

Specifically, the search range is a search range related to content displayed on the display screen or a search range related to a device corresponding to the display screen. The device corresponding to the display screen is a source of content being displayed on the display screen.

Specifically, the search range may be preset, or determined in a certain manner which comprises, but not limited to, the manner in the foregoing embodiments.

Optionally, the search range comprises any one of the following: at least one piece of content displayed on at least one contact area of the at least one body part and the display screen, at least one piece of content being displayed on the display screen, at least one application program corresponding to at least one piece of content being displayed on the display screen, at least one application program being run by a device corresponding to the display screen, and at least one database connected to a device corresponding to the display screen, wherein the at least one database may be connected to the device through a network.

In this embodiment, a search result may further be displayed after 120.

Optionally, after the performing a search at least according to the at least one piece of content, the method further comprises:

displaying at least one search result.

In order to push the at least one search result to a user more obviously, optionally, the displaying at least one search result comprises:

displaying the at least one search result on at least one contact area of the at least one body part and the display screen.

Generally, each body part and the display screen have one contact location. The at least one contact area is specifically defined by at least one contact location of the at least one body part and the display screen. Specifically, each contact location can define one contact area, or multiple contact locations can define one contact area together.

In an application of this embodiment, it is assumed that an index finger fingerprint of a right hand of a user is associated with a word “a mobile phone”, and a middle finger fingerprint of the right hand is associated with a word “4G”. In a possible scenario, the user uses a mobile phone to view a document. When the user wants to search for at least one part comprising “a mobile phone” in the document, the user may complete a predetermined movement such as a double-click operation on a display screen of the mobile phone using an index finger of the right hand, and a search apparatus of the mobile phone performs a search in the document according to the word “a mobile phone” and jumps currently displayed content to a part comprising the word “a mobile phone”, and further, optionally, displays the word “a mobile phone” in the part in a location, on which the index finger of the right hand of the user performs the double-click operation, on the display screen. In another possible scenario, the mobile phone of the user is displaying a page of a search engine. When the user wants to search for content comprising both the word “a mobile phone” and the word “4G”, the user may complete a predetermined movement such as a double-click operation on the display screen of the mobile phone using the index finger of the right hand and a middle finger of the right hand and control the index finger of the right hand and the middle finger of the right hand in a short distance, for example, the distance is shorter than 2 cm, and the search apparatus of the mobile phone performs a search in the search engine according to a search formula—“a mobile phone” and “4G”; and when the user wants to search for content comprising “a mobile phone” but not comprising “4G”, the user may complete the predetermined movement such as the double-click operation on the display screen of the mobile phone using the index finger of the right hand and the middle finger of the right hand and control the index finger of the right hand and the middle finger of the right hand make motion in back to back directions after the predetermined movement is completed, and the search apparatus of the mobile phone performs a search in a database of the search engine according to a search formula—“a mobile phone” xor “4G”.

FIG. 2 is a schematic structural diagram of a search apparatus in Embodiment 1 provided in the present application. As shown in FIG. 2, a search apparatus 200 comprises:

a first determination module 21, configured to, in response to a predetermined movement of at least one body part on a display screen, determine at least one piece of content associated with at least one biological feature of the at least one body part; and

a search module 22, configured to perform a search at least according to the at least one piece of content.

In this embodiment, the search apparatus 200 is optionally set in a user terminal in a manner of hardware and/or software. Further, the display screen is also set in the user terminal, or the display screen is connected to the user terminal.

In this embodiment, the at least one body part comprises, but not limited to, at least one of the following: at least one finger, at least one palm, at least one toe, and at least one sole.

In this embodiment, the predetermined movement comprises, but not limited to, any one of the following: a double-click, a triple-click, pressing concurrently with a double-click, and pressing concurrently with a triple-click. For example, if the body part is at least one finger, the double-click may be a finger performing a double-click operation on the display screen, or two fingers performing the double-click operation on the display screen simultaneously, or the like; and pressing concurrently with a double-click may be one finger pressing the display screen and the other finger performing the double-click operation on the display screen simultaneously, or one finger pressing the display screen and another two fingers performing the double-click operation on the display screen simultaneously, or the like.

In this embodiment, the predetermined movement of the at least one body part on the display screen may be detected and determined by the search apparatus 200, and may also be detected and determined by another apparatus that notifies the search apparatus 200.

In this embodiment, at least one biological feature of each body part may identify the body part. For example, at least one biological feature of a finger may comprise a fingerprint of the finger; at least one biological feature of a toe may comprise a toe print of the toe; at least one biological feature of a palm may comprise a palm print of the palm; at least one biological feature of a sole may comprise a sole print of the sole.

In this embodiment, the at least one piece of content comprises, but not limited to, at least one of the following content: character, picture, audio clip, and video clip. The character comprises, but not limited to, at least one of the following characters: letter, number, word, symbol, and the like.

In this embodiment, an association relationship between the at least one biological feature and the at least one piece of content may be pre-established by the search apparatus 200 or another apparatus. Specifically, the association relationship may be one biological feature associated with one piece of content, or one biological feature associated with multiple pieces of content, or multiple biological features associated with one piece of content, or multiple biological features associated with multiple pieces of content. Optionally, in a process in which a user uses at least one body part to select at least one piece of content on the display screen, an association relationship between at least one biological feature of the at least one body part and the selected at least one piece of content is established. For example, a user uses an index finger and a middle finger of his right hand selecting one piece of content displayed on the display screen. Correspondingly, an association relationship between an index finger fingerprint and a middle finger fingerprint of the right hand of the user and the content may be established, that is, two biological features are associated with one piece of content. A user uses an index finger of his right hand selecting one piece of content A displayed on the display screen, and a middle finger of the right hand selecting another piece of content B displayed on the display screen simultaneously. Correspondingly, an association relationship between an index finger fingerprint of the right hand of the user and the content A and an association relationship between a middle finger fingerprint of the right hand of the user and the content B may be established, that is, two biological features are respectively associated with two pieces of content.

In this embodiment, the at least one piece of content is used by the search module 22 as content provided for a search entrance in the search, and a function thereof is similar to a search word or a search strategy.

In the search apparatus in this embodiment, a search solution is provided by, in response to a predetermined movement of at least one body part on a display screen, determining, by a determination module, at least one piece of content associated with at least one biological feature of the at least one body part; and performing, by a search module, a search at least according to the at least one piece of content. Moreover, a search entrance is opened and content needed by a search is provided for the search entrance by means of a predetermined movement of at least one body part, which speeds up the search.

The following further describes the search apparatus 200 in this embodiment through some optional embodiments.

In this embodiment, the first determination module 21 has multiple embodiments.

In a possible scenario, the at least one body part is one body part. Correspondingly, the first determination module 21 is specifically configured to:

in response to a predetermined movement of the one body part on the display screen, determine at least one piece of content associated with at least one biological feature of the body part.

In another possible scenario, the at least one body part includes multiple body parts. Correspondingly, the first determination module 21 is specifically configured to:

in response to a predetermined movement of the multiple body parts on the display screen, determine at least one piece of content associated with multiple biological features of the multiple body parts.

In this scenario, optionally, the first determination module 21 is specifically configured to: in response to a predetermined movement of at least one body part on the display screen, determine multiple pieces of content associated with multiple biological features of the multiple body parts.

In this scenario, optionally, as shown in FIG. 3, the search apparatus 200 further comprises:

a second determination module 23, configured to determine relative location relationships and/or relative motions of the multiple body parts on the display screen.

The relative location relationships comprise, but are not limited to, at least one of the following: a distance, an upper-lower relationship, and a left-right relationship. For example, a distance of two fingers of a user on the display screen may be 1 cm, 2 cm, or the like; an upper-lower relationship of two fingers of a user on the display screen may be one finger being upper and the other finger being lower, or the two fingers being horizontally aligned; and a left-right relationship of two fingers of a user on the display screen may be one finger being left and the other finger being right, or the two fingers being vertical aligned.

The relative motions comprise, but are not limited to, any one of the following: motion in the same direction, motion in face to face directions, and motion in back to back directions. Specifically, the motion in the same direction refers to moving substantially in a same direction; the motion in face to face directions refers to moving substantially in opposite directions towards a same location; and the motion in back to back directions refers to moving substantially in opposite directions from a same location.

In consideration of the predetermined movement executed by the multiple body parts on the display screen, the relative motions may be relative motions after the multiple body parts have executed the predetermined movement on the display screen.

Considering that the multiple body parts may move on the display screen, the relative location relationships may be relative location relationships when the multiple body parts execute the predetermined movement on the display screen, or relative location relationships after the multiple body parts have executed the predetermined movement and completed relative motion.

Specifically, the second determination module 23 is specifically configured to: determine the relative location relationships of the multiple body parts on the display screen; or determine the relative motions of the multiple body parts on the display screen; or determine the relative location relationships and the relative motions of the multiple body parts on the display screen.

Further, the relative location relationships and/or the relative motions may have multiple functions in the search.

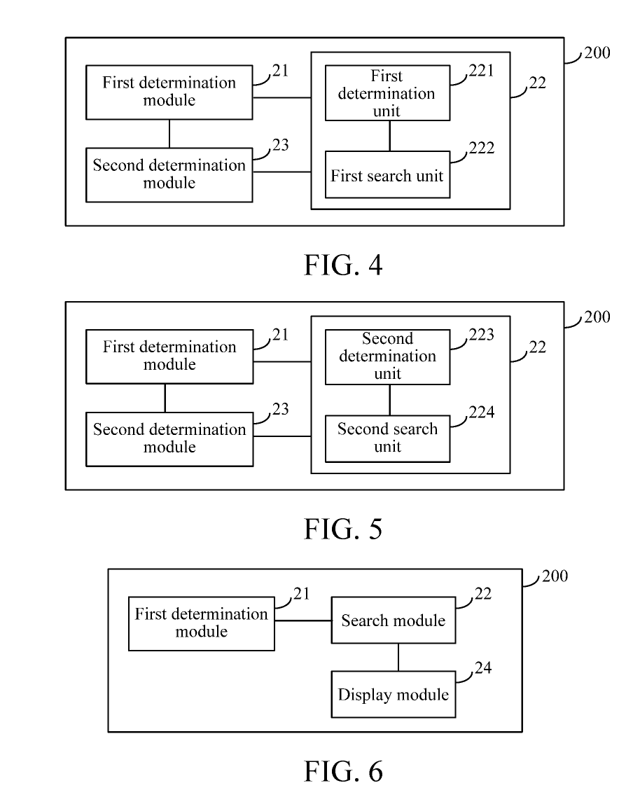

Optionally, as shown in FIG. 4, the search module 22 comprises:

a first determination unit 221, configured to determine a search range according to the relative location relationships and/or the relative motions; and

a first search unit 222, configured to perform the search in the search range at least according to multiple pieces of content.

Specifically, the search range is a search range related to content displayed on the display screen or a search range related to a device corresponding to the display screen. The device corresponding to the display screen is a source of content being displayed on the display screen.

Optionally, the search range comprises, but not limited to, any one of the following: at least one piece of content displayed on at least one contact area of the at least one body part and the display screen, at least one piece of content being displayed on the display screen, at least one application program corresponding to at least one piece of content being displayed on the display screen, at least one application program being run by a device corresponding to the display screen, and at least one database connected to a device corresponding to the display screen, wherein the at least one database may be connected to the device through a network.

For example, a user uses a finger to execute a predetermined movement on a display screen of a mobile phone, and the mobile phone is running two application programs, wherein one is a document editing program, and the other is a web page browser; the document editing program opens two documents, and the web page browser opens two web pages; and the display screen is displaying page 2 of a document, and the finger is in contact with a location of a word in a paragraph displayed on the display screen. Correspondingly, the search range determined by the first determination unit 221 may be the paragraph, or the document being displayed, or the two documents opened by the document editing program, or the two documents opened by the document editing program and the two web pages opened by the web page browser, or all network search engines to which the mobile phone can be connected, or the like.

Specifically, the first determination unit 221 is specifically configured to: determine the search range according to the relative location relationships; or determine the search range according to the relative motions; or determine the search range according to the relative location relationships and the relative motions.

For example, when a distance of two fingers that execute the predetermined movement on the display screen on the display screen is short, for example, when the distance is shorter than 2 cm, the first determination unit 221 determines that the search range is at least one piece of content displayed on at least one contact area of the two fingers of the display screen; and when the distance of the two fingers that execute the predetermined movement on the display screen on the display screen is long, for example, when the distance is longer than 2 cm, the first determination unit 221 determines that the search range is the at least one application program corresponding to the at least one piece of content being displayed on the display screen.

For another example, when the two fingers that execute the predetermined movement on the display screen make the motion in back to back directions on the display screen after completing the predetermined movement, the first determination unit 221 determines that the search range is the at least one database connected to the device corresponding to the display screen; and when the two fingers that execute the predetermined movement on the display screen make the motion in the same direction on the display screen after completing the predetermined movement, the first determination unit 221 determines that the search range is the at least one application program being run by the device corresponding to the display screen.

For another example, when one of the two fingers that execute the predetermined movement on the display screen is upper and the other is lower, and the two fingers make the motion in face to face directions on the display screen after completing the predetermined movement, the first determination unit 221 determines that the search range is the at least one piece of content being displayed on the display screen; and when the two fingers that execute the predetermined movement on the display screen are horizontally aligned on the display screen, and the two fingers make the motion in back to back directions on the display screen after completing the predetermined movement, the first determination unit 221 determines that the search range is the at least one application program being run by the device corresponding to the display screen.

In the foregoing scenario in which the first determination module 21 is specifically configured to in response to a predetermined movement of multiple body parts on the display screen, determine multiple pieces of content associated with multiple biological features of the multiple body parts. Optionally, as shown in FIG. 5, the search module 22 comprises:

a second determination unit 223, configured to determine logical relationships between the multiple pieces of content according to the multiple pieces of content, and the relative location relationships and/or the relative motions; and

a second search unit 224, configured to perform the search at least according to the multiple pieces of content and the logical relationships between the multiple pieces of content.

Specifically, the logical relationships may comprise, but not limited to, at least one of the following relationships: “and”, “or”, “xor”, or the like.

Specifically, the second determination unit 223 is specifically configured to: determine the logical relationships between the multiple pieces of content according to the multiple pieces of content and the relative location relationships; determine the logical relationships between the multiple pieces of content according to the multiple pieces of content and the relative motions; and determine the logical relationships between the multiple pieces of content according to the multiple pieces of content, and the relative location relationships and the relative motions.

For example, when a distance of the two fingers that execute the predetermined movement on the display screen on the display screen is short, for example, when the distance is shorter than 2 cm, the second determination unit 223 determines that a logical relationship between two pieces of content respectively associated with fingerprints of the two fingers is “and”; when a distance of the two fingers that execute the predetermined movement on the display screen on the display screen is long, for example, when the distance is longer than 2 cm, the second determination unit 223 determines that the logical relationship between the two pieces of content respectively associated with the fingerprints of the two fingers is “or”; and when a distance two fingers of three fingers that execute the predetermined movement on the display screen on the display screen is short, and a distance between the two fingers and the another finger is long, the second determination unit 223 determines that a logical relationship between content associated with the fingerprints of the two fingers between which the distance is short is “and”, and a logical relationship between the content associated with the fingerprints of the two fingers between which the distance is short and content associated with a fingerprint of the another finger is “or”.

For another example, when the two fingers that execute the predetermined movement on the display screen make the motion in back to back directions on the display screen after completing the predetermined movement, the second determination unit 223 determines that the logical relationship between the two pieces of content respectively associated with the fingerprints of the two fingers is “xor”; and when the two fingers that execute the predetermined movement on the display screen make the motion in the same direction on the display screen after completing the predetermined movement, the second determination unit 223 determines that the logical relationship between the two pieces of content respectively associated with the fingerprints of the two fingers is “and”.

For another example, when one of the two fingers that execute the predetermined movement on the display screen is upper and the other is lower, and the two fingers make the motion in back to back directions on the display screen after completing the predetermined movement, the second determination unit 223 determines that a logical relationship between two pieces of content respectively associated with fingerprints of the two fingers is content associated with an upper fingerprint “xor” content associated with a lower fingerprint; and when the two fingers that execute the predetermined movement on the display screen are horizontally aligned on the display screen, and the two fingers make the motion in the same directions on the display screen after completing the predetermined movement, the second determination unit 223 determines that the logical relationship between the two pieces of content respectively associated with the fingerprints of the two fingers is “and”.

In this embodiment, the search generally has a search range.

Optionally, the search module 22 is specifically configured to: perform the search in a search range at least according to the at least one piece of content.

Specifically, the search range is a search range related to content displayed on the display screen or a search range related to a device corresponding to the display screen. The device corresponding to the display screen is a source of content being displayed on the display screen.

Specifically, the search range may be preset, or determined in a certain manner which comprises, but not limited to, the manner in the foregoing embodiments.

Optionally, the search range comprises any one of the following: at least one piece of content displayed on at least one contact area of the at least one body part and the display screen, at least one piece of content being displayed on the display screen, at least one application program corresponding to at least one piece of content being displayed on the display screen, at least one application program being run by a device corresponding to the display screen, and at least one database connected to a device corresponding to the display screen, wherein the at least one database may be connected to the device through a network.

In this embodiment, a search result may further be displayed after the search module 22 performs the search.

Optionally, as shown in FIG. 6, the search apparatus 200 further comprises:

a display module 24, configured to display at least one search result.

In order to push the at least one search result to a user more obviously, optionally, the display module 24 is specifically configured to: display the at least one search result on at least one contact area of the at least one body part and the display screen.

Generally, each body part and the display screen have one contact location. The at least one contact area is specifically defined by at least one contact location of the at least one body part and the display screen. Specifically, each contact location can define one contact area, or multiple contact locations can define one contact area together.

In an application of this embodiment, it is assumed that an index finger fingerprint of a right hand of a user is associated with a word “a mobile phone”, and a middle finger fingerprint of the right hand is associated with a word “4G”. In a possible scenario, the user uses a mobile phone to view a document. When the user wants to search for at least one part comprising “a mobile phone” in the document, the user may complete a predetermined movement such as a double-click operation on a display screen of the mobile phone using an index finger of the right hand, and the search apparatus 200 of the mobile phone performs a search in the document according to the word “a mobile phone” and jumps currently displayed content to a part comprising the word “a mobile phone”, and further, optionally, displays the word “a mobile phone” in the part in a location, on which the index finger of the right hand of the user performs the double-tap operation, on the display screen.

In another possible scenario, the mobile phone of the user is displaying a page of a search engine. When the user wants to search for content comprising both the word “a mobile phone” and the word “4G”, the user may complete a predetermined movement such as a double-click operation on the display screen of the mobile phone using the index finger of the right hand and a middle finger of the right hand and control the index finger of the right hand and the middle finger of the right hand in a short distance, for example, the distance is shorter than 2 cm, and the search apparatus of the mobile phone performs a search in the search engine according to a search formula—“a mobile phone” and “4G”; and when the user wants to search for content comprising “a mobile phone” but skipping comprising “4G”, the user may complete the predetermined movement such as the double-click operation on the display screen of the mobile phone using the index finger of the right hand and the middle finger of the right hand and control the index finger of the right hand and the middle finger of the right hand make motion in back to back directions after the predetermined movement is completed, and the search apparatus 200 of the mobile phone performs a search in a database of the search engine according to a search formula—“a mobile phone” xor “4G”.

Reference of specific implementation of this embodiment may be made to corresponding description in a search method embodiment provided in the present application.

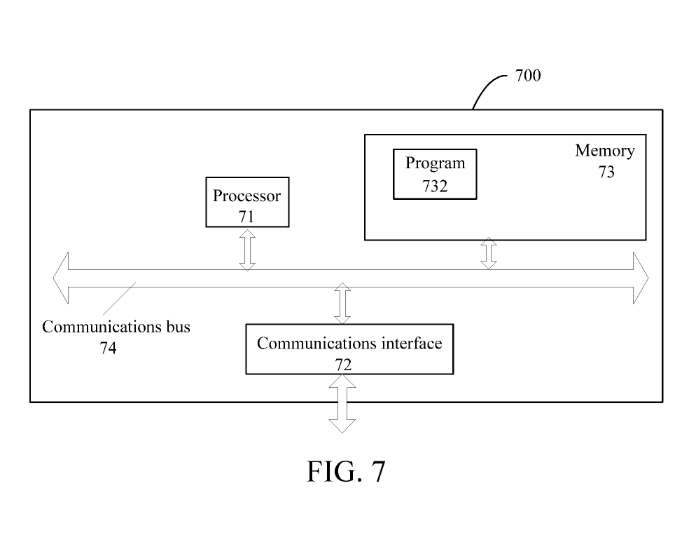

FIG. 7 is a schematic structural diagram of a search apparatus in Embodiment 2 provided in the present application. As shown in FIG. 7, a search apparatus 700 comprises:

a processor 71, a communications interface 72, a memory 73, and a communications bus 74.

The processor 71, the communications interface 72, and the memory 73 communicate with each other by using the communications bus 74.

The communications interface 72 is configured to communicate with a peripheral device such as a display screen.

The processor 71 is configured to execute a program 732, and may specifically implement relevant steps of the foregoing search method embodiments.

Specifically, the program 732 may comprise program code, wherein the program code comprises a computer operation instruction.

The processor 71 may be a central processing unit (CPU), or an application specific integrated circuit (ASIC), or may be configured as one or more integrated circuits that implement the search method embodiments.

The memory 73 is configured to store the program 732. The memory 73 may comprise a high speed random access memory (RAM), and may also comprise a non-volatile memory such as at least one magnetic disk memory. The program 732 may be specifically configured to enable the search apparatus 700 to perform the following steps:

in response to a predetermined movement of at least one body part on a display screen, determining at least one piece of content associated with at least one biological feature of the at least one body part; and

performing a search at least according to the at least one piece of content.

For the specific implementation of the steps in the program 732, refer to the corresponding descriptions of corresponding steps and units in the foregoing search method embodiments, which are not described herein again.

It can be appreciated by a person of ordinary skill in the art that, exemplary units and method steps described with reference to the embodiments disclosed in this specification can be implemented by electronic hardware or a combination of computer software and electronic hardware. Whether these functions are executed by hardware or software depends on specific applications and design constraints of the technical solution. A person skilled in the art may use different methods to implement the described functions for each specific application, but such implementation should not be construed as a departure from the scope of the present application.

If the function is implemented in the form of a software functional unit and is sold or used as an independent product, the product can be stored in a computer-readable storage medium. Based on this understanding, the technical solution of the present application essentially, or the part that contributes to the prior art, or a part of the technical solution may be embodied in the form of a software product; the computer software product is stored in a storage medium and comprises several instructions for enabling a computer device (which may be a personal computer, a server, a network device, or the like) to execute all or some of the steps of the method in the embodiments of the present application. The foregoing storage medium comprises: any medium that can store program code, such as a USB flash drive, a removable hard disk, a read-only memory (ROM), a RAM, a magnetic disk, or an optical disc.

The foregoing implementations are only used to describe the present application, but not to limit the present application. A person of ordinary skill in the art can still make various alterations and modifications without departing from the spirit and scope of the present application; therefore, all equivalent technical solutions also fall within the scope of the present application, and the patent protection scope of the present application should be subject to the claims.

1. A search method, comprising:
in response to a predetermined movement of at least one body part on a display screen, determining at least one piece of content associated with at least one biological feature of the at least one body part; and
performing a search at least according to the at least one piece of content.

2. The method of claim 1, wherein the at least one body part includes multiple body parts.

3. The method of claim 2, wherein the method further comprises:
determining relative location relationships and/or relative motions of the multiple body parts on the display screen.

4. The method of claim 3, wherein the relative location relationships comprise at least one of a distance, an upper-lower relationship, and a left-right relationship.

5. The method of claim 3, wherein the relative motions comprise any one of the following: motion in the same direction, motion in face to face directions, and motion in back to back directions.

6. The method of claim 3, wherein the performing a search at least according to the at least one piece of content comprises:
determining a search range according to the relative location relationships and/or the relative motions; and
performing the search in the search range at least according to multiple pieces of content.

7. The method of claim 3, wherein the in response to a predetermined movement of at least one body part on a display screen, determining at least one piece of content associated with at least one biological feature of the at least one body part comprises:
in response to a predetermined movement of multiple body parts on the display screen, determining multiple pieces of content associated with multiple biological features of the multiple body parts.

8. The method of claim 7, wherein the performing a search at least according to the at least one piece of content comprises:
determining logical relationships between the multiple pieces of content according to the multiple pieces of content, and the relative location relationships and/or the relative motions; and
performing the search at least according to the multiple pieces of content and the logical relationships between the multiple pieces of content.

9. The method of claim 1, wherein the performing a search at least according to the at least one piece of content comprises:
performing the search in a search range at least according to the at least one piece of content.

10. The method of claim 9, wherein the search range is preset.

11. The method of claim 6, wherein the search range comprises any one of the following: at least one piece of content being displayed on at least one contact area of the at least one body part and the display screen, at least one piece of content being displayed on the display screen, at least one application program corresponding to at least one piece of content being displayed on the display screen, at least one application program being run by a device corresponding to the display screen, and at least one database connected to a device corresponding to the display screen.

12. The method of claim 1, wherein after the performing a search at least according to the at least one piece of content, the method further comprises:
displaying at least one search result.

13. The method of claim 12, wherein the displaying at least one search result comprises:
displaying the at least one search result on at least one contact area of the at least one body part and the display screen.

14. The method of claim 1, wherein the predetermined movement comprises any one of the following: a double-click, a triple-click, pressing concurrently with a double-click, and pressing concurrently with a triple-click.

15. The method of claim 1, wherein the at least one body part comprises at least one of the following: at least one finger, at least one palm, at least one toe, and at least one sole.

16. An apparatus, comprising:
a first determination module, configured to, in response to a predetermined movement of at least one body part on a display screen, determine at least one piece of content associated with at least one biological feature of the at least one body part; and
a search module, configured to perform a search at least according to the at least one piece of content.

17. The apparatus of claim 16, wherein the at least one body part includes multiple body parts.

18. The apparatus of claim 17, wherein the apparatus further comprises:
a second determination module, configured to determine relative location relationships and/or relative motions of the multiple body parts on the display screen.

19. The apparatus of claim 18, wherein the relative location relationships comprise at least one of the following: a distance, an upper-lower relationship, and a left-right relationship.

20. The apparatus of claim 18, wherein the relative motions comprise any following: motion in the same direction, motion in face to face directions, and motion in back to back directions.

21. The apparatus of claim 18, wherein the search module comprises:
a first determination unit, configured to determine a search range according to the relative location relationships and/or the relative motions; and
a first search unit, configured to perform the search in the search range at least according to multiple pieces of content.

22. The apparatus of claim 18, wherein the first determination module is configured to:
in response to a predetermined movement of multiple body parts on the display screen, determine multiple pieces of content associated with multiple biological features of the multiple body parts.

23. The apparatus of claim 22, wherein the search module comprises:
a second determination unit, configured to determine logical relationships between the multiple pieces of content according to the multiple pieces of content, and the relative location relationships and/or the relative motions; and
a second search unit, configured to perform the search at least according to the multiple pieces of content and the logical relationships between the multiple pieces of content.

24. The apparatus of claim 16, wherein the search module is configured to:
perform the search in a search range at least according to the at least one piece of content.

25. The apparatus of claim 24, wherein the search range is preset.

26. The apparatus of claim 21, wherein the search range comprises any one of the following: at least one piece of content displayed on at least one contact area of the at least one body part and the display screen, at least one piece of content being displayed on the display screen, at least one application program corresponding to at least one piece of content being displayed on the display screen, at least one application program being run by a device corresponding to the display screen, and at least one database connected to a device corresponding to the display screen.

27. The apparatus of claim 16, wherein the apparatus further comprises:
a display module, configured to display at least one search result.

28. The apparatus of claim 27, wherein the display module is configured to:
display the at least one search result on at least one contact area of the at least one body part and the display screen.

29. The apparatus of claim 16, wherein the predetermined movement comprises any one of the following: a double-click, a triple-click, pressing concurrently with a double-click, and pressing concurrently with a triple-click.

30. The apparatus of claim 16, wherein the at least one body part comprises at least one of the following: at least one finger, at least one palm, at least one toe, and at least one sole.

31. A computer readable storage device comprising executable instructions that, in response to execution, cause a device comprising a processor to perform operations, comprising:
in response to a predetermined movement of at least one body part on a display screen, determining at least one piece of content associated with at least one biological feature of the at least one body part; and
performing a search at least according to the at least one piece of content.
